(19) United States
(12) Patent Application Publication
(10) Pub. No.: US 2024/0272072 A1
(43) Pub. Date: Aug. 15, 2024

(54) Sorption-Induced Tunable Fiber Optic Plasmonic Gas Sensing

(71) Applicant: Battelle Memorial Institute, Columbus, OH (US)

(72) Inventors: Jeffrey Culp, Wexford, PA (US); Ki-Joong Kim, Pittsburgh, PA (US); Jeffrey Wuenschell, Columbus, OH (US)

(21) Appl. No.: 18/438,355

(22) Filed: Feb. 9, 2024

Related U.S. Application Data
(60) Provisional application No. 63/444,232, filed on Feb. 9, 2023.

(51) Int. Cl. G01N 21/552; G01N 21/64; G01N 21/77

(52) U.S. Cl. CPC G01N 21/554; G01N 21/648; G01N 21/7703; G01N 2021/6484

(57) ABSTRACT

An optical fiber comprising a layer of coating composition disposed on the exterior of a glass fiber. The layer of coating composition comprises plasmonic nanocrystals dispersed in a porous polymer such as one or a plurality of polymers with intrinsic microporosity (PIMS). The layer of coating composition may be a composite comprising polymer and functionalized plasmonic nanocrystals. A method of making the coated optic fiber is also described. The coated optic fiber can be used to make a sensor and measure an analyte by measuring light transmission through the fiber.

### RELATED APPLICATIONS

This application claims the priority benefit of U.S. Provisional Patent Application Ser. No. 63/444,232, filed 9 Feb. 2023, which is incorporated herein as if reproduced in full below.

### GOVERNMENT RIGHTS

This invention was made with funding from the Department of Energy under contract number 89243318CFE000003, the government has certain rights in the invention.

### INTRODUCTION

Sensitive and selective sensing of gases relevant to fossil energy, such as carbon dioxide (CO₂) and methane (CH₄) is becoming increasingly important in environmental and industrial fields. In particular, there exists a need for a low cost, continually monitoring sensing system capable of functioning within a distributed network which is remotely deployable over a wide range of environmental and geographical conditions, including above-ground and subterranean sites. For example, CO₂ leakage detection, quantification and management are crucial to ensuring safe and cost-effective monitoring of carbon storage sites. Pipeline monitoring along natural gas gathering, and transmission lines is essential for minimizing the environmental impacts and threats to public safety from natural gas leaks. National goals of transitioning to a more hydrogen intensive energy infrastructure will require new sensing systems for monitoring hydrogen transmission and storage. For these and related sensing applications, fiber optic (FO)-based sensing systems offer advantages in both distribution range and deployment flexibility. FO sensing systems, which operate at similar wavelengths and use much of the same hardware as optimized for the telecommunications industry, possess a distinct advantage. This overlap will also provide a route to more rapid deployment of FO sensing systems if the proper FO sensor coatings and monitoring techniques can be realized.

Currently, optical sensing based on non-dispersed infrared (NDIR) absorption is most often used for the detection of CO₂ (Phys. Rev. 1932, 41, 291-303; IEEE Trans. Instrum. Meas. 2005, 54, 1634-1639; Analyst 2014, 139, 3572-3576.). This technique is robust, sensitive and very selective due to the specificity of the absorption wavelengths. However, it currently requires a large sensing volume and an expensive bulky optical system, which makes them unsuitable for remote sensing applications. A more attractive alternative fiber optic (FO) sensing design is to use evanescent wave absorption spectroscopy-based sensors. In general, the FO transmission (% T) for evanescent wave absorption spectroscopy-based sensors is typically attenuated through absorption and/or scattering losses within a sensing layer coated onto the optical fiber core. If an FO is coated with a functional material that could selectively interact with the analyte gas of interest, e.g. CO₂, CH₄, H₂, then transmittance over the length of the FO will be modified, thus enabling long-range distributed sensing (ACS Sens. 2018, 3, 386-394; Sens. Actuators, B 2016, 232, 43-51; Opt. Lett. 2016, 41, 1696-1699; ACS Appl. Mater. Interfaces 2021, 13, 2062-2071). To achieve optimal transmission ranges, attenuation of the FO signal must be minimized. This is best achieved by matching the operational wavelength of the sensor to one of the “telecommunication windows”. As such, an ability to tune the optimal operation of the FO sensor is very important for maximizing the range and deployment of an evanescent wave absorption spectroscopy-based FO sensor. The wavelength-tunable FO sensor coating disclosed herein provides this unique benefit.

Optical sensors utilizing the localized surface plasmon resonance (LSPR) in nanoparticles (NPs) as signal transducers are powerful techniques due to their strong confinement and enhancement of the electromagnetic field near the NPs surface (Nat. Photonics 2010, 4, 83-91; Chem. Rev. 2011, 111, 38283857; Chem. Soc. Rev., 2014, 43, 3426-3452). In this field, the integration of plasmonic materials such as Pd (ACS Sens. 2020, 5, 978-983), Ag (ACS Nano 2020, 14, 2345-2353), Au (Nat. Commun. 2013, 4, 2381), Pd-metal alloys (Nano Lett. 2015, 15, 3563-3570; Nat. Mater. 2019, 18, 489-495; Nanoscale, 2018, 10, 20533 20539; Nat. Commun. 2021, 12, 2414), Hf (Nat. Commun. 8, 15718), as nanoarchitectures are essential to play in tuning the electromagnetic response of the plasmon coupling through the control of the plasmonic component spacing and arrangement (J. Phys. Chem. C 2016, 120, 34, 19353-19364). Using nanoarchitectures, numerous sensor concepts have been developed, wherein nanofabrication approaches based on photo-lithography are mainly employed for plasmonic sensing functions. However, this requires extensive capital investment and limits the technology to sensor arrays on two-dimensional platforms. Therefore, it is necessary to develop new ways to integrate the plasmonic materials to enable the widespread utilization of plasmonic sensors, as well as flexible and scalable integrating processing routes toward various platforms such as three-dimensional FO sensor.

In addition, until recently, specific gas-sensitive plasmonic NPs (pNPs) were employed for the detection of chemical species but are limited to only highly reactive gases such as H₂, O₂, CO, CH₄, H₂S (doi.org/10.1002/asia.202100885; Angew. Chem., Int. Ed. 2014, 53, 12081-12085). The challenge of utilizing the pNPs as signal transducers for sensing chemically stable gases such as CO₂ remains unsolved at room temperature (ACS Appl. Mater. Interfaces 2018, 10, 42552-42563).

Sensor devices integrated with polymers on fiber optic platforms have been developed for gas sensor applications. These devices used polymers as membranes or membrane-like components, and gas-sensitive indicators were incorporated to form the active gas sensor component of a gas sensor device.

The layers coated on the fiber end-tip were for point measurements. Quantification analysis was determined by measuring the absorption bands of target gases. For example, CO₂ and O₂ monitoring in blood were measured at 1.6 microns and 1.9 to 2.05 microns. Ahern et al. in U.S. Ser. No. 11/170,986 describes a luminescence-based fiber optic probe for the detection of rare earth elements. Other patented inventions use the polymer's changing refractive index as a sensing signal. The optical fiber-based polymer core sensor can measure a temperature, a strain, a distance, a refractive index, and monitor a chemical process (e.g., chemical plants, energy industry, air bubbles in the concrete, resin curing, etc.), or a combination thereof. Examples are (note that all patents mentioned herein are incorporated in full as if reproduced in full below):
U.S. Pat. No. 5,453,248 A, 1992—Cross-linked gas permeable membrane of a cured perfluorinated urethane polymer, and optical gas sensors fabricated therewith.
U.S. Pat. No. 5,233,194 A, 1992—Optical gas sensor with enriching polymer.
US 2021/0206689, —Fiber optic temperature measurement with quantum dot nanocomposite
WO2010028319A2, 2010—Optical fiber-based polymer core sensor.

The invention described here does not require indicator dyes which change color or intensity upon reaction with the analyte gas, instead the sensors operate by changes in % transmitted light down the length of the fiber due to changes in refractive index within the sensor coating upon adsorption of the analyte gas. In the present invention, plasmonic nanoparticles provide a measurable loss in transmitted light intensity at the desired wavelength. The invention does not use absorption bands in the NIR spectrum of the analyte gas for detection. The inventive sensors can be designed to have multiple sensing sites along the length of the fiber and not simply a terminal point measurement as described in the patent. The invention allows numerous sensing elements to be placed along the length of the fiber and also allows coupling to distributed interrogation methods for determining which sensor element along the fiber is reacting to the analyte gas and giving a sensor response. An advantage is that the number of locations along the length of the pipeline, for example, can be monitored using a single fiber. In addition, the inventive sensor can be designed for remote interrogation and incorporation into a distributed network with multiple sensing sites along a pipeline, for example, over long distances of 10 s-100 s of kilometers.

Incorporation strategies of colloidal plasmonic nanoparticles into polymer matrix have been reported. Examples include:
U.S. Ser. No. 10/113,924B2, 2018—Plasmonic nanoparticle-based colorimetric stress memory sensor.
U.S. Pat. No. 7,427,491B2, 2008—Nanoparticle for optical sensors.
U.S. Pat. No. 8,999,244 B2, 2015—Chemical sensors based on cubic nanoparticles capped with an organic coating.
U.S. Pat. No. 9,632,050 B2, 2017—Flexible multi-moduled nanoparticle-structured sensor array on polymer substrate and methods for manufacture.
U.S. Pat. No. 7,253,004 B2, 2007—Chemical sensors from nanoparticles/dendrimer composite materials.

The present invention differs in several ways. The present invention relates to a chemical sensor comprising a sensor film formed of a nanoparticle network in which the nanoparticles are embedded in a polymer matrix by using functionalized plasmonic nanoparticles. The inventive optic sensing element may be composed of porous materials with a high surface area and/or high gas solubility, which enhances the refractive index (RI) changes in the sensor coating layer by increasing the amount of analyte gas adsorbed in the coating. The leads to an overall loss in transmitted light down the fiber. Changes in light intensity are much easier to monitor than complex interference fringes. The present invention may tune the operational frequency of our sensor to the optimal range for commercial-grade fiber optics.

Sorption-induced refractive index (RI) change with the microporous metal-organic frameworks thin films on two-dimensional or three-dimensional sensor platforms has been reported for sensor applications. Examples are:
Guang Lu et al., “Engineering ZIF-8 Thin Films for Hybrid MOF-Based Devices”, Advanced Materials, 2012, 24, 3970-3974. (doi.org/10.1002/adma.201202116).
Guang Lu et al., “Fabrication of Metal-Organic Framework-Containing Silica-Colloidal Crystals for Vapor Sensing”, Advanced Materials, 2011, 23, 4449-4452. (doi.org/10.1002/adma.201102116).
Ki-Joong Kim et al., “Metal-Organic Framework Thin Film Coated Optical Fiber Sensors: A Novel Waveguide-Based Chemical Sensing Platform”, ACS Sensors, 2018, 3, 386-394. (doi.org/10.1021/acssensors.7b00808).

The present invention differs in several ways. First, the invention utilizes plasmonic nanoparticles pNPs as signal transducers for sensing chemically stable gases such as CO₂ at room temperature. Utilizing pNPs with strong LSPR bands in the near-infrared (NIR) offers the potential to transmit a signal through a low-cost FO within the telecommunication application window (1550 nm). In addition, fine-tuning the localized surface plasmon resonance (LSPR) peak to match the overtune of the vibration bands of CO₂ gas molecules at NIR wavelengths (1572 nm), highly sensitive Near infrared (NIR) absorption CO₂ gas sensors could be used to monitor real-time changes of absorption in plasmonic materials due to free carrier density changes.

Sorption-induced LSPR shifts in the interfacial plasmonic composite materials have been demonstrated for CO₂ sensor applications. They use a transparent planar substrate in thin film devices, where the metal-organic frameworks or polymers are integrated directly as a spacer layer on top of nanostructured gold disks. Examples include:
Lauren Kreno et al., “Metal-Organic Framework Thin Film for Enhanced Localized Surface Plasmon Resonance Gas Sensing”, Analytical Chemistry, 2010, 82, 19, 8042-8046. (doi.org/10.1021/ac102127p).
Thomas Lang et al., “Surface plasmon resonance sensor for dissolved and gaseous carbon dioxide”, Analytical Chemistry, 2012, 84, 21, 9085-9088. (doi.org/10.1021/ac301673n).
Tobias Pohl et al, “Optical Carbon Dioxide Detection in the Visible Down to the Single Digit ppm Range Using Plasmonic Perfect Absorbers”, ACS Sensors, 2020, 5, 2628-2635. (doi.org/10.1021/acssensors.0c01151).
Ferry A. A. Nugroho et al., “UV—Visible and Plasmonic Nanospectroscopy of the CO2 Adsorption Energetics in a Microporous Polymer”, Analytical Chemistry, 2015, 87, 10161-10165. (doi.org/10.1021/acs.analchem.5b03108).

The present invention differs in several ways. Homogeneous distribution of pNPs within the polymer matrix is one of the critical factors in enhancing sensor sensitivity. Our invention reports a strategy for the incorporation of colloidal pNPs homogeneously in a microporous polymer matrix. This strategy involves functionalizing colloidal pNPs surfaces that prevent agglomeration or phase separation. This is a new application thus provides an approach for realizing sorption-induced plasmonic sensing gases.

### SUMMARY OF THE INVENTION

In a first aspect, the invention provides an optical fiber comprising a layer of coating composition disposed on the exterior of a glass fiber; and wherein the layer of coating composition comprises: plasmonic nanocrystals dispersed in a porous polymer; or a composite comprising polymer and functionalized plasmonic nanocrystals.

In any of its aspects, the invention can be further characterized b one or any combination of the following: wherein the plasmonic nanocrystals are functionalized with an amine or wherein the plasmonic nanocrystals are functionalized with (3-Aminopropyl)triethoxysilane, 1-Dodecanethiol, Trioctylphosphine, polyethylene glycol, ethylenediaminetetraacetic acid, polyvinyl pyrrolidone, polyvinyl alcohol; wherein the plasmonic nanocrystals comprise indium-tin-oxide (ITO); or wherein the porous polymer has a volume average pore size in the range of 0.4 to 1.0 nm; or wherein the porous polymer has a pore volume is in the range of 0.1 to 1.0 cm³/g; wherein the optical fiber has performance such that under a dry atmosphere containing one atm CO2 and 20° C. there is a change of transmittance at near-infrared wavelengths of 20% or less or 10% or less or 5% or less over 300 days under the same conditions; wherein the coating has a refractive index within 0.30 or within 0.10 or within 0.05 of the glass fiber; wherein the coating has a refractive index within the range of 1.30 to 1.75 or 1.40 to 1.70, more preferably within the range of 1.45-1.65 or within the range of 1.45-1.55; further comprising an optical response enhancer in the coating that is a light absorbing material that, when present in the polymer matrix exhibits at least two times greater absorption, or at least 5 times, or in the range of 2 to ten times or five to ten times greater absorption of the light reflected from the sensor coating at the measurement wavelength as compared to the absorption from the coating without enhancer and as compared to the coating in the absence of CO₂ and CH₄; wherein the plasmonic nanocrystals have at least one dimension in the mass average size range of 1 nm to 30 nm or 2 nm to 20 nm, or 5 to 20 nm, or 20 to 200 nm based on the smallest diameter of the particles; wherein the plasmonic nanocrystals have spherical or rod-shaped particles; wherein the length of the coating is 2 to 20 cm, more preferably 3 to 15 cm, more preferably 5 to 10 cm; wherein the coating further comprises a zeolite or metal organic framework, or porous carbon; wherein the polymer comprises PIM1 or PIM7 or PTMSP; wherein the coating composition comprises 5-50 wt %, or 5 to 30 wt %, or 20 to 40 wt % plasmonic nanocrystals; and at least 50 wt % polymer, or 60 to 95 wt % polymer (the concentration of nanoparticles in the coating can be changed to determine the wavelength of operation); wherein at least 50 mass % or at least 80 mass % of the nanocrystals have sizes in the range of 5 to 40 nm, or 5 to 25 nm, or 6 to 20 nm; comprising rod-shaped nanoparticles having an aspect ratio of at least 10; wherein the porous polymer comprises a microporous or mesoporous polymer as defined by IUPAC (Goldbook); or wherein the thickness of the coating on the fiber is between 2 and 30 μm or 2 and 15 μm, or 2 and 8 μm.

In another aspect, the invention provides a sensor, comprising: a glass fiber coated with the coating composition of any of the above claims. In the sensor, the glass fiber is disposed in a metal or plastic tube having a plurality of holes formed along the length of the tube. In some cases, the glass fiber is disposed in a fluoropolymer sleeve. The sensor may further comprise an impermeable protective tube comprising a fluid inlet and a fluid outlet and a fluid channel disposed between the fluid inlet and the outlet wherein the fluid channel contacts and is adjacent to the coated glass fiber, the sleeve, or the metal or plastic tube. The sensor may further comprise: a light source attached to one end of the glass fiber, a measurement device attached to the other end of the glass fiber; and a telemetry device.

In a further aspect, the invention provides a method of making a composite, comprising: functionalizing plasmonic nanocrystals with an amine; mixing the functionalized plasmonic nanocrystals with a PIM polymer to form a suspension; applying the suspension to a substrate, and curing or setting the polymer. In any of the aspects, the plasmonic nanocrystals may comprise ITO or gold nanorods, and/or wherein the substrate is a glass fiber; and/or wherein the suspension comprises an organic carrier fluid that evaporates or separates during formation of a solid film.

In another aspect, the invention provides a method of measuring an amount of a molecule of interest, comprising: exposing the sensor of any of the above claims to the molecule of interest, and measuring light transmission through the fiber. Preferably, the target molecule of interest is CO₂, H₂ or CH₄. The inventive aspects can be further characterized by the data, for example, placing the sensor underground in an aqueous environment, exposing the sensor to the molecule of interest in the aqueous environment for at least eight continuous months and wherein the sensitivity of the sensor (signal intensity/analyte concentration) decreases by 20% or less.

The invention may be further characterized by any selected descriptions from the data, for example, within ±30%, ±20% (or within ±10%) of any of the values in any of the data, tables or figures; however, the scope of the present invention, in its broader aspects, is not intended to be limited by these examples. As is standard patent terminology, the term “comprising” means “including” and does not exclude additional components. Any of the inventive aspects described in conjunction with the term “comprising” also include narrower embodiments in which the term “comprising” is replaced by the narrower terms “consisting essentially of” or “consisting of.” As used in this specification, the terms “includes” or “including” should not be read as limiting the invention but, rather, listing exemplary components. As is standard terminology. “systems” include to apparatus and materials (such as reactants and products) and conditions within the apparatus. All ranges are inclusive and combinable. For example, when a range of “1 to 5′ is recited, the recited range should be construed as including ranges “1 to 4”, “1 to 3”, “1-2”, “1-2 & 4-5”, “1-3 & 5”, “2-5”, any of 1, 2, 3, 4, or 5 individually, and the like.

### BRIEF DESCRIPTION OF THE DRAWINGS

FIG. 1 shows the fabrication scheme and characterization of pNPs-polymer film. a. Processing scheme for the preparation of a pNPs-polymer film on a FO sensor platform. b. Transmission electron microscopy image of colloidal ITO pNPs with an average diameter of 11.6±0.98 nm (Inset of high-resolution transmission electron microscopy image showing a single crystalline particle). c. Cross-section and d. top scanning electron microscopy images of 200 nm thick pNPs-polymer film on the FO sensor platform. e. Elemental distributions (In, Sn, O) determined by energy dispersive spectroscopy analysis of the pNPs-polymer film on the FO sensor. Scale bar is 200 nm.

FIG. 2 shows optical responses of PNPs-polymer. a. Transmission spectra of pNPs₄₀-polymer FO sensor by exposing different concentrations of CO₂. The asterisk indicates the junction point between the two spectra readout of Visible and NIR range. b. Transmission spectra of neat polymer and pNPs-polymer films on planar substrates in air. c. Correlation between the Tmax at 486 nm and 1225 nm on neat polymer and pNPs-polymer FO sensors to different concentration of CO₂. d. CO₂ concentration dependent ΔT at 486 nm and 1225 nm on neat polymer and pNPs-polymer FO sensors. Optical isotherms of neat polymer and pNPs-polymer FO sensors constructed from ΔT in FIG. 2b. e. Transmission spectra of pNPs-polymer FO sensors with different pNPs contents in polymer matrix upon 100% CO2 exposure. The orange stars indicate the wavelength of the Tₘₐₓ. f. Optical isotherms of pNPs-polymer FO sensors with different pNPs contents in polymer matrix. AT were measured at Tₘₐₓ=1658 nm for 8 wt % pNPs, Tₘₐₓ=1434 nm for 24 wt % pNPs, Tₘₐₓ=1225 nm for 40 wt % pNPs in polymer matrix, respectively. The solid lines in FIGS. 2d and 2f correspond to a regression analysis from Langmuir-Freundlich adsorption model.

FIG. 3 shows transmission in %. a. % T of ITO pNPs, neat PIM-1, and layered polymer/pNPs films on FO sensors upon CO₂ exposure. b. Dynamic response of layered pNPs/polymer films on FO sensors to different CO₂ concentrations.

FIG. 4 shows transmission spectra. a. % T spectra of pNPs-ptmsp polymer FO sensor by exposing CO₂. b. % T spectrum of Au NRs-polymer film on the planar substrate in air. c. % T spectra of Au NRs-polymer FO sensor by exposing CO₂. d. Optical isotherms of Au NRs-polymer FO sensors. ΔT were measured at Tₘₐₓ=627 nm. The solid lines in FIG. 4d correspond to a regression analysis from the Langmuir-Freundlich adsorption model.

FIG. 5 shows response times of neat polymer and pNPs-polymer FO sensors. Sensor response to 100% CO₂ for sensor coatings of a. neat polymer and b. pNPs-polymer. c. Dynamic ΔT responses to 3 cycles of 6 different CO₂ concentration on fresh and >40 weeks-aged neat polymer and pNPs-polymer FO sensors at ambient conditions. Dynamic responses were measured at 486 nm for the neat polymer sensor and at 1225 nm for the pNPs-polymer FO sensor.

FIG. 6 shows stability of neat polymer and pNPs-polymer FO sensors. a. Response times of fresh and >40 weeks-aged of neat polymer and pNPs-polymer FO sensors. b. ΔT of fresh and >40 weeks-aged neat polymer and pNPs-polymer sensors upon 100% CO₂ exposure. c. N2 adsorption-desorption of fresh and >40 weeks aged neat polymer and pNPs-polymer. d. Pore size distribution of fresh and >40 weeks-aged neat polymer and pNPs-polymer.

FIG. 7 illustrates a sensing apparatus.

### DETAILED DESCRIPTION OF THE INVENTION

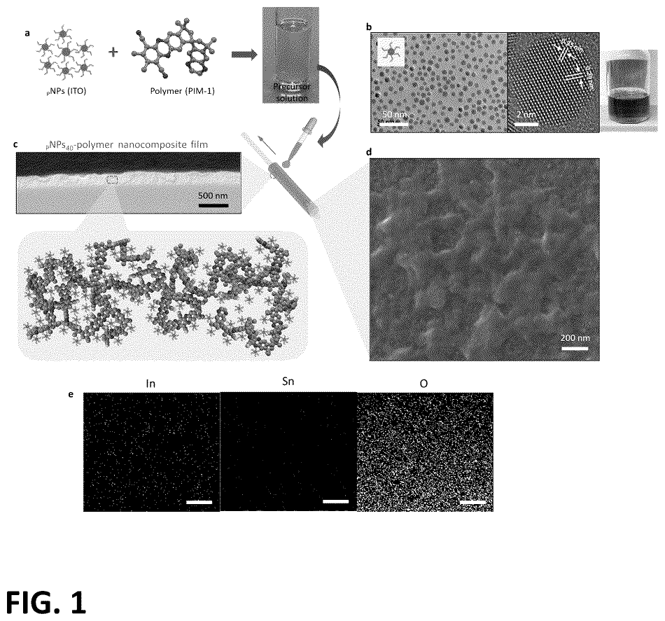

The invention provides a sorption-induced tunable fiber optic plasmonic gas sensing. In this invention, we developed an incorporation strategy of colloidal pNPs into a microporous polymer matrix for realizing a new sorption-induced tunable plasmonic sensing technique. This strategy involves the surface functionalization of pNPs and the demonstration of the pNPs-polymer composite films on FO for gas sensors, particularly CO₂ gas (FIG. 1a). We synthesized colloidal tin-doped indium oxide (ITO) pNPs grafted with oleylamine (FIG. 1b). ITO pNPs were then added into a polymer solution. The maximum amount of ITO pNPs for a miscible precursor solution is a weight ratio (wt %) of ITO/polymer/toluene/chloroform=1:2.5:95:490. This precursor solution showed an exceptional stability for more than three years without aggregation. Casting this solution produces a film consisting of 40 wt % ITO pNPs (6.7 vol %) in a polymer matrix (This recipe will be referred to as pNPS₄₀-polymer). This recipe will be referred to as pNPs₄₀-polymer. Scanning electron microscopy images show dense and uniform films without any visible defects and uniformly dispersed pNPs without obvious particle aggregation (FIGS. 1c and 1d). Elemental analysis also supports the homogeneous dispersion of ITO pNPs in the whole polymer matrix (FIG. 1e).

The invention provides a method to fabricate a new class of an LSPR-based sensor layer by the combination of pNPs and porous polymer. The facile integration of uniform pNPs-polymer films on sensor platforms to provide rapid and fully reversible responses to a range of CO₂ concentrations through sorption-induced plasmonic sensing. By suppressing the general aging issue of the porous polymer over time, we show that the sensor can operate at atmospheric conditions (room temperature and 1 bar) without significant signs of degradation (preferably 10% or less or 5% or less), even after 10 months. Significant advantages of this method include (1) the incorporation of various sizes and shapes of pNPs building blocks which possess tailored LSPRs with large electromagnetic field enhancements and (2) providing a faster response by tailoring the volume-to-surface ratio. This approach uses polymers to immobilize the pNPs, while the pNPs serve as the functional material to control the optical contrast. As evidenced by sorption studies, optical responses of pNPs-polymer follow the adsorption behavior of the porous polymer. The pNPs-polymer composites are applicable to a broad range of sensor materials which offer advantages in tailorability through the selection of pNPs shape, size and concentration within a broad family of porous polymers.

The invention provides an optical fiber comprising the coating composition of disposed on the exterior of a glass fiber. Preferably, the glass fiber is at least 90 wt % silica, or at least 99 wt % silica. In a coated glass fiber, the sensor coating is in direct contact with that part of the optical fiber where light is transmitted by total internal reflection. Preferably, we want the coating to have a similar refractive index to the core. The coating preferably has a refractive index within 0.15 or within 0.10 or within 0.05 of the core. For example, for a typical fiber refractive index of 1.45, the refractive index of the coating is within the range of 1.30 to 1.60, more preferably within the range of 1.35-1.55 more preferably within the range of 1.40-1.50.

The invention also provides a sensor, comprising: a glass fiber coated with the coating composition. The glass fiber can be disposed in a metal or plastic tube having a plurality of holes formed along the length of the tube. In some preferred embodiments, the glass fiber is disposed in a fluoropolymer sleeve. The sensor may further comprise an impermeable protective tube comprising a fluid inlet and a fluid outlet and a fluid channel disposed between the fluid inlet and the outlet wherein the fluid channel contacts and is adjacent to the coated glass fiber, the sleeve, or the metal or plastic tube. There may be a light source attached to one end of the glass fiber, a measurement device attached to the other end of the glass fiber; and a telemetry device. The protective tube for our fiber sensor is designed to prevent direct contact of the aqueous solution with the sensing section of the optical fiber, but allow permeation of the analyte gas from the aqueous solution to the sensor surface.

The invention provides a method of making a composite, comprising: mixing a suspension of polymer, functionalized plasmonic nanocrystals); applying the suspension to a substrate, and curing or setting the polymer. In preferred embodiments the substrate is a fiber optic. The polymer can be cured or set by known methods such as thermal setting, UV light, or reactive cross-linking. In some preferred embodiments, the substrate is a glass fiber. The composition, typically in an organic carrier fluid (preferably a volatile carrier fluid such as hexane that evaporates or separates during formation of the solid film). Preferably, the coating is applied over a particular region of the substrate in 10 seconds or less and is cured within 10 minutes of coating. If the starting substrate is an optical fiber that has cladding, we have to strip the polymer jacket and etch away a section of the cladding to expose the core and then deposit the sensor coating directly onto the core. Another approach is to use a coreless termination fiber as the sensor section; this optical fiber doesn't have a cladding component, only a polymer jacket surrounding the glass fiber; in this case, we strip the polymer away, and replace it with our sensor coating which has a lower refractive index so the light does not escape from the fiber. The coating is in direct contact with the glass fiber where light is propagating. Long coating length may increase fragility, so we typically coat about 5 to 10 cm section and then splice the sensor-coated coreless section into a long length of the normal cladded optical fiber. We just need the two glass core sections to be the same diameter. Longer coatings to any length, for example 50 cm or more, can be made with a reel-to-reel coating system.

The invention includes a method of measuring an amount of a molecule of interest, comprising: exposing the sensor to the molecule of interest, and measuring light transmission through the fiber. The invention can include: placing the sensor underground in an aqueous environment, exposing the sensor to the molecule of interest in the aqueous environment for at least eight continuous months and wherein the sensitivity of the sensor (signal intensity/analyte concentration) decreases by 20% or less. Preferably, the target molecule of interest is CO₂, H₂ or CH₄.

While described in conjunction with various preferred embodiments, the invention may include: use of other colloidal plasmonic nanomaterials that exhibits an localized surface plasmon resonance (LSPR); use of solid nanoparticles that preferably can graft with polymer chain; use of physi-sorbents nanoparticles such as metal-organic framework, activated carbons, or zeolites that preferably can graft with polymer chain; use of other porous polymers to disperse plasmonic nanomaterials; use of fluorescent nanomaterials such as fluorescent nano-diamonds or carbon dots; use of other nanomaterials/organic dyes to enhance the optical properties/sensitivity of the sensors; use of any physical adsorption of gases into porous polymer resulting in a refractive index change of the sensor layer; use of other types of optical fibers, such as multimode, coreless, tapered single mode, etc.; monitoring of liquid solutions or solvent vapors; gas monitoring at temperatures or pressures significantly above or below ambient conditions.

This method/invention may include any application where leak detection or monitoring of light gases or vapors is needed; preferably the method is conducted at conditions of 0-100° C., 1-100 bar; monitoring gas transmission and delivery pipelines including natural gas, methane, hydrogen/methane, ethane, ethylene, propane, propylene, or any volatile hydrocarbon; monitoring capped or abandoned nature gas wells, plume monitoring, and leak detection of CO₂ sequestration sites; used for other plasmon-enhanced optical sensors such as plasmon-enhanced fluorescence (PEF), surface-enhanced Raman scattering (SERS), and surface-enhanced infrared absorption spectroscopy (SEIAS); integrated the pNPs-polymer into electrical/acoustic-based sensors such as surface acoustic wave devices, piezoelectric crystals, and quartz crystal microbalances; monitoring indoor or outdoor air quality (air pollution); detecting volatile organic compounds in environmental monitoring; monitoring other gases CH₄ and H2 leak detection; utilized as polymeric membrane-type hybrid structures by coupling molecular sieving and sorption behavior in gas separation applications.

This invention can provide a variety of advantages such as:
the ability to uniformly incorporate various sizes and shapes of pNPs possessing tailored LSPRs with sizeable electromagnetic field enhancements into a polymer matrix. In preferred embodiments, selecting a 1 cm length of coating (could be within a longer coating) wherein the concentration of pNPs in any 25% continuous section of the length is within 20% or within 10% or within 5% of the average concentration of pNPs of the 1 cm of length; or alternatively wherein the concentration of pNPs in any 25% section of thickness (for example, the thickness adjacent to the fiber) is within 20% or within 10% or within 5% of the average concentration of pNPs of the whole thickness.
the ability to broadly tune the operational wavelength by controlling the concentration of fixed-size nanoparticles within the polymer matrix, providing a low-cost, highly scalable approach to generate sensors with customizable peak wavelength response or for wavelength multiplexing for use in quasi-distributed sensing applications.
the ability to deposit dense and thin layers of a mixed polymer/nanoparticle matrix (e.g., 300-800 nm).
rapid formation of a self-standing sensor layer which requires no post-processing.
the ability to enhance the sensitivity of the sensor by preventing agglomeration or phase separation of pNPs in the sensor layer.
the ability to significantly reduce the aging issue of a polymer with intrinsic microporosity by dispersing pNPs grafted with amphiphilic ligands within the polymer, therefore enhancing the stability of the sensor performance.
the ability to supply a rapid sensor response (a few tens of seconds) to a % T change in gas concentration at ambient conditions with excellent reproducibility, while operating on a fully reversible physisorption mechanism.
more flexible and scalable processing toward various sensor platforms as compared to the photolithography technique, thereby significantly reducing the costs to monitor target gases, particularly in remote locations.

Plasmonic nanocrystals are particles whose electron density can couple with wavelengths of light that are far larger than the particle due to the nature of the dielectric-conductor interface between the medium (polymer in this case) and the nanocrystals. In a preferred embodiment, the plasmonic nanocrystals are indium-tin-oxide (ITO). In the present invention, a “plasmonic nanocrystal” is a nanoscale particle consisting of a metal or mixture of metals, or metal oxide or mixture of metal oxides that, when present in the polymer matrix which coats an optical fiber, after room temperature saturation with CO₂ or CH₄, exhibits at least 50% greater absorption at the measurement wavelength as compared to the coating without plasmonic nanocrystals and as compared to the coating in the absence of CO₂ and CH₄, more preferably at least two times, or at least 5 times, or in the range of 2 to ten times or five to ten times. Preferably, this increase in optical response is an increase in absorbance (relative to background) within a wavelength range of 400-2500 nm when the coating is saturated with CO₂. Preferably, at least 90 mass % of the plasmonic nanocrystals have at least one dimension in the size range of 1 nm to 30 nm or 2 nm to 20 nm, or 5 to 20 nm, or 20 to 200 nm based on the smallest diameter of the particles, which, in some embodiments, are spherical or rod-shaped.

The polymer in the polymer matrix is a porous polymer that allows passage of the analyte of interest. Preferred polymers have (volume avg) pore sizes in the range of 0.4 to 1.0 nm. A preferred pore volume is in the range of 0.1 to 1.0 cm³/g. Preferred polymers are PIMS. Polymers with intrinsic microporosity (PIMS) are characterized by having macromolecular structures that are both rigid and contorted so as to have extremely large fractional free volumes. Examples include poly(1-trimethylsilyl-1-propyne) (PTMSP), poly(4-methyl-2-pentyne) (PMP) and polybenzodioxane (PIM-1). Because of their exceptional free volume, all are extremely permeable. PIM-type materials may also be characterized by having repeat units of dibenzodioxane-based ladder-type structures combined with sites of contortion, which may be those having spiro-centers or severe steric hindrance. The chain structures of PIMs prevent dense chain packing, causing considerably large accessible surface areas and high gas permeability. PIM structures are also described in U.S. Pat. Nos. 9,920,168, 8,623,928, 10,076,728, 9,371,429, and 10,434,479 which are incorporated herein.

The functionalizing agent bonds to the nanoparticles and stabilizes the resulting coating. The functionalizing agent is preferably an amphiphilic compound that attaches to the nanoparticles and grafts to the polymer. Where the functionalizing agent comprises a polymer, it is preferably a low molecular weight polymer in the range of 200 to 2000 Daltons.

The coating composition preferably comprises 5-50 wt %, or 5 to 30 wt %, or 20 to 40 wt % plasmonic nanocrystals; and at least 50 wt % polymer, or 60 to 95 wt % polymer.

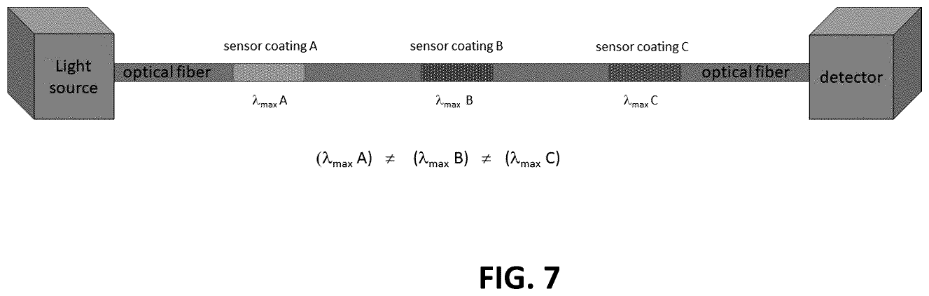

The sensor may include two or more sensor sections within a single strand of optical fiber, as shown in the schematic below. Each sensing section would be coated with a sensor coating containing an optical enhancer tuned to have an absorption maximum at different wavelengths. For example, sensor coating A could have an additive with an absorption maximum at 600 nm, coating B an absorption maximum at 900 nm, and coating C an absorption maximum at 1300 nm (these wavelengths are arbitrary choices for demonstration purposes). The light source would be capable of transmitting near monochromatic light at each of the wavelengths corresponding to the maximum absorption wavelength of each sensor section. Incident light of each wavelength could be sequentially pulsed and monitored by the broadband detector over time. If a sensing event occurred at one of the sensor sections, it would be distinguished by loss in transmitted power relative to the baseline corresponding to the wavelength of that particular sensor section (see FIG. 7).

The invention in various aspects also includes: a coating material; methods of measuring CO₂ or other gases; methods of making a coating, coated fiber, and/or device; devices incorporating a coating or coated fiber; and/or a system comprising the coating or coated fiber or device in combination with compositions such as gases and/or liquids, pressure and/or temperature. The invention can also be characterized by any of the measurements described herein and/or within ±50%, or ±30%, ±20%, ±10% of the measured values, quantities, and/or concentrations described herein.

The chemical moieties at the surface of ITO pNPs were studied by infrared spectroscopy, confirming characteristic bands of oleylamine. The hydrophobic behavior of ITO pNPs in toluene suggests methyl group termination, implying that the amine group in oleylamine is preferentially grafted to the surface of the ITO pNPs. The stable precursor solution was established by adding the ITO ₚNP solution into the PIM-1 solution. The maximum amount of ITO ₚNPs for a miscible precursor solution is a weight ratio (wt %) of ITO/PIM1/toluene/chloroform=1:2.5:95:490. When this solution is cast as a film, this recipe leads to a 40 wt % ITO ₚNPs (6.7 vol %) in a polymer matrix. This recipe will be referred to as ₚNPS₄₀-polymer. This precursor solution showed an extremely stable behavior for over three years without aggregation. Next, a room-temperature coating process was used to fabricate the pNPs-polymer films on the FO cable. This process is flexible to other soluble polymers in common organic solvents, permitting the integration of a thin sensor layer (a few hundred nanometers) and requires no post-processing, simplifying scale-up and reducing costs. SEM images indicate dense and uniform films without visible defects and uniformly dispersed pNPs without apparent particle aggregation. The elemental analysis also supports the uniformity of ITO PNPs throughout the PIM-1 matrix. In addition, XRD patterns confirm that the embedded ITO ₚNPs remain crystalline.

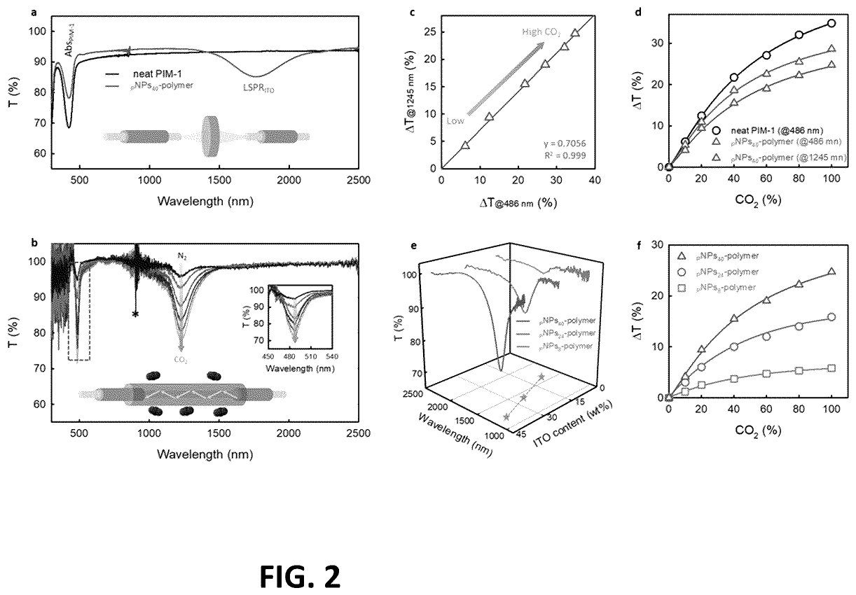

As shown in FIG. 2a, a normal incidence % T measurement of a pNPS₄₀-polymer film coated on a planar quartz substrate exhibits two distinct absorption bands: one originating from the absorption of PIM-1 at ˜486 nm (Carbon, 2016, 102, 357-366), and a second one in the NIR region at ˜1810 nm, associated with the LSPR absorption of ITO pNPS₄₀ (Nano Lett., 2011, 11, 4415). When the pNPsopolymer FO sensor is exposed to a different CO₂ concentration, two distinct stepwise change in transmission spectra appeared at 486 and 1225 nm, respectively. This observation is different to a normal incidence transmittance of pNPs-polymer film on planar substrate showing two distinct peaks (FIG. 2b). These two optical spectra clearly show a linear correlation between the transmittance and CO₂ concentration (FIG. 2c). As such, this correlated optical behavior can be used as a signal transducer for sensing gases. Through additional analysis, we proved that this optical response to CO₂ of the pNPs-polymer film on FO occurs in the epsilon near zero region of the ITO ₚNPs.

Optical isotherms constructed from the CO₂ concentration dependent transmission changes (ΔT) follow the “Langmuir-Freundlich model” (Interface Science and Technology, 2021, 33, 445-509) for a Type 1 isotherm indicative of an adsorption process occurring within the micropores of the pNPs-polymer matrix (FIG. 2d). This correlation confirms that the optical response of the pNPs-polymer FO sensor is a direct result of gas adsorption occurring within the porous polymer matrix. A series of pNPspolymer composite films with varying the amounts of pNPs, from 8 wt % to 40 wt %, i were additionally prepared to further investigate this optical response. Upon CO₂ exposure, Tₘₐₓ in the NIR range redshifts with decreasing amounts of pNPs in polymer matrix (FIG. 2c). Interestingly, the Tₘₐₓ shows a linear correlation with the amount of ITO ₚNPs in the polymer matrix. As seen in FIG. 2f, sensitivity is also correlated with pNPs concentration. A monotonic increase in sensor sensitivity is observed with increasing pNPs loading in the polymer matrix.

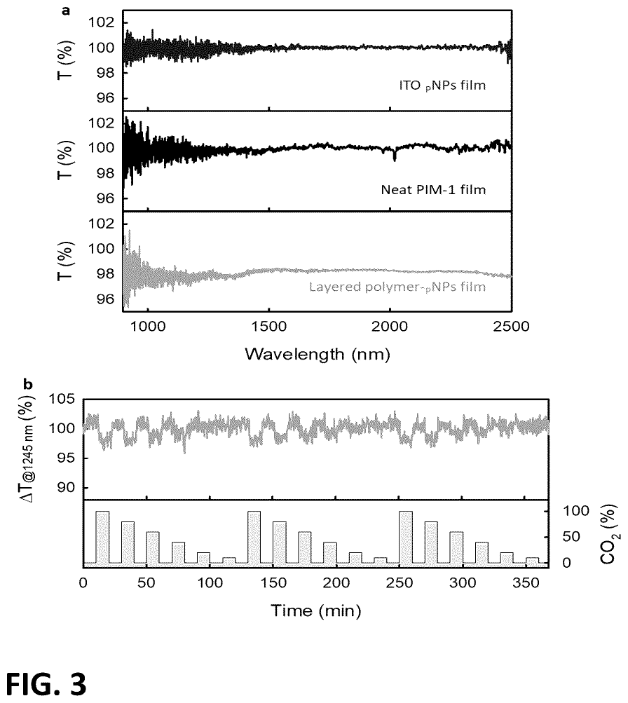

Sequential deposition of layered PIM-1/ITO/FO further proved the importance of the interaction between pNPs and polymer on the optical properties. In this case, ITO ₚNPs were first deposited directly onto the surface of the FO and then coated with a PIM-1 layer. In contrast to the homogeneously dispersed pNPs-polymer coating, the % T spectra of the layered PIM-1/ITO/FO structure to CO₂ exposure revealed a minimal change in % T at ˜1245 nm (FIG. 3). This is due to the limited interaction of the polymer with the surface of the pNPs. This result indicates that the homogeneous distribution of pNPs in a polymer matrix is critical for the observed sensing response. Note that FO sensors coated with either pure ITO PNPs or neat PIM-1 polymer exhibited no distinct changes in % T in the NIR range upon CO₂ exposure.

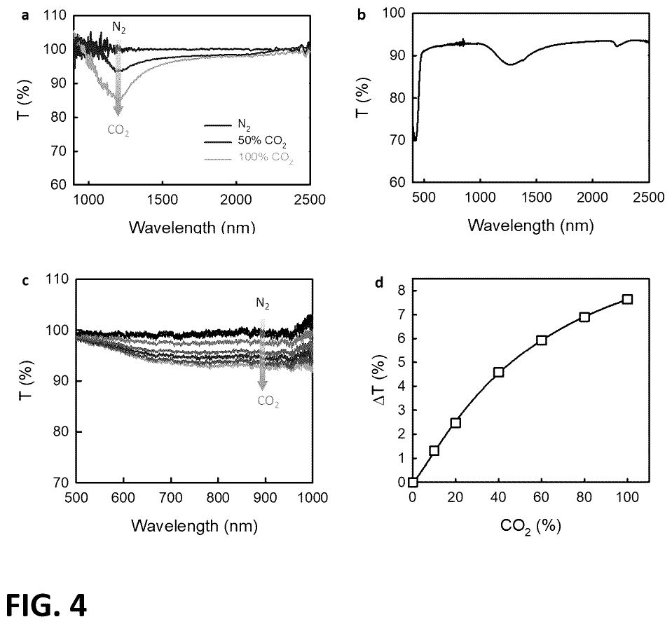

The properties of the pNPs-polymer interaction were further investigated by using a colorless porous polymer poly(1-trimethylsilyl-1-propyne) (ptmsp), which is also widely studied for CO₂ separation applications (Chem. Rev. 2018, 118, 5871-5911; Polym. Chem., 2017, 8, 3341-3350). When the pNPs-ptmsp FO sensor is exposed to CO₂ gas, a similar Tₘₐₓ is observed, appearing around 1200 nm (FIG. 4a). The slight difference in the location of Tₘₐₓ is likely associated with the different RIs between PIM-1 (1.590) and ptmsp (1.497) polymers. The impact of the polymer RI on the expected response is discussed in detail in the following section. We also found that the strategy of incorporating colloidal pNPs into a polymer matrix could be extended to other nanostructured objects of different sizes and shapes. For example, gold nanorods (Au NRs, 10 nm×81 nm) were successfully incorporated into PIM-1 polymer using this strategy (FIG. 4b). The % T of the Au NRs-polymer film deposited on a planar substrate displays a strong plasmon absorption at ˜1250 nm. However, when the same coating is applied to an optical fiber, the plasmon band of the Au NRs-polymer FO sensor upon CO₂ exposure appears at 627 nm, thus showing a similar blue-shift in the plasmon band of approximately 600 nm as observed in the pNPs-polymer FO sensor readings (FIG. 4c). The optical isotherm constructed from the CO₂ concentration-dependent response fits very well with the Langmuir-Freundlich model, indicating a sorption-induced plasmon response on FO platform (FIG. 4d).

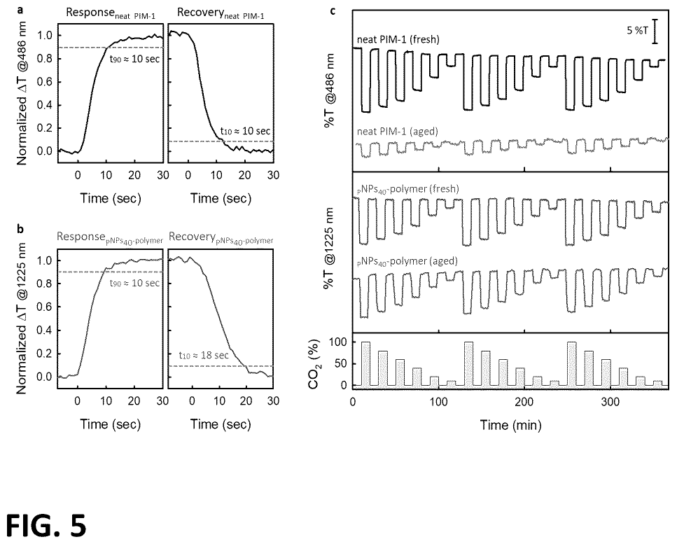

Sensor performance of pNPs-polymer FO sensors shows fast response times on the order of seconds, indicating no limiting CO₂ gas diffusion through the polymer sensor film. We observed identical sensing response times to 100% CO₂ for the fresh neat polymer and pNPs-polymer FO sensors (FIGS. 5a and 5b). The dynamic sensing performance of both sensors was investigated by exposing them to pulses of gradually decreasing CO₂ concentration in N2 carrier gas (FIG. 5c). Both sensors exhibited consistent and reliable responses to the different CO₂ concentrations at room temperature. In turn, pNPs-polymer FO sensor show approximately 21% lower sensitivity compared to neat polymer FO sensor. The initial sensing response of the neat PIM-1 polymer coating indicated that the polymer could be utilized as sensor material (Polymers 2018, 10, 280; Langmuir 2010, 26, 3767-3770; Sensors 2011, 11, 2478-2487) however, the sensing performance of the neat PIM-1 polymer FO sensor shows a drift in dynamic optical response over time with a significant reduction of sensor signal (more than 80%) after >40 weeks exposure in air (FIG. 5c). This degradation in sensor performance is due to physical aging of the polymer matrix. This well-known aging effect significantly reduces the pore volume and gas sorption within the polymer and limits its application in gas separation or capture processes (ACS Appl. Mater. Interfaces 2020, 12, 41, 46756-46766; Chem. Rev. 2018, 118, 5871-5911).

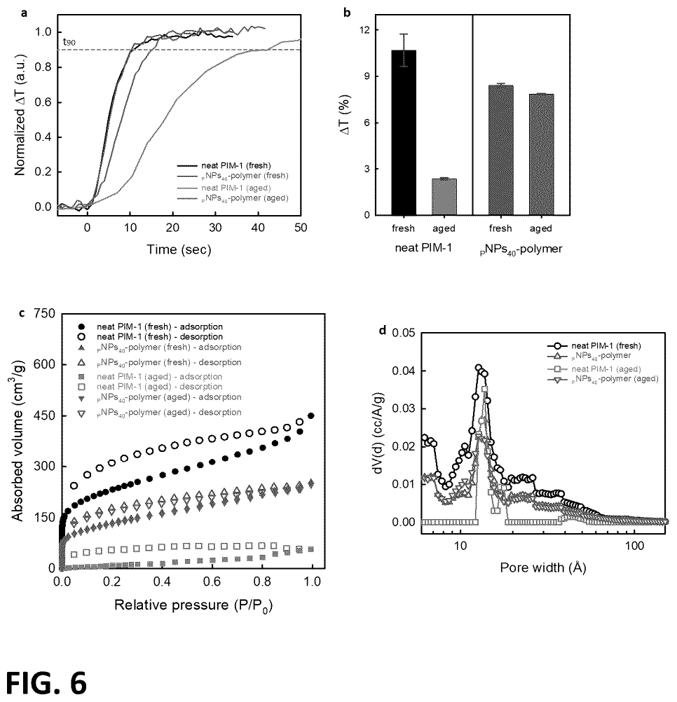

Sensor performance was further investigated after >40 weeks of exposure to ambient conditions. As shown in FIG. 6a, the pNPs-polymer FO sensor retained its response, while the neat polymer FO sensor showed a significant drop in performance with an increase in response time. For example, the response time to 100% CO₂ of the aged pNPs-polymer FO sensor is ˜14 seconds, while the response time of the aged neat polymer FO sensor is ˜41 seconds. From the results shown in FIG. 6b, it is clear that proper incorporation of pNPs into the polymer matrix greatly enhance the long-term stability of the sensor relative to the neat polymer coating. The sensitivity of the aged pNPs-polymer FO sensor showed only a slight decrease in sensitivity of ˜7% as compared to freshly prepared sensor. Further evidence for an enhanced stability of the pNPs-polymer matrix was obtained from N2 gas adsorption isotherms (FIG. 6c). Fresh neat polymer shows the characteristics of a microporous material as defined by IUPAC; however, the Brunauer-Emmett-Teller (BET) surface area of neat polymer decreased significantly from 827 to 70 m² g⁻¹ after 40 weeks (Table 1). The incorporation of pNPs into the polymer resulted in a decrease in the BET surface area by 1.7 times, compared to neat polymer. Most of this apparent reduction in BET surface area is expected due to the added mass fraction of nonporous pNPs into the sample and as such is not indicative of a physical change in the polymer. Pore size distribution results provided additional evidence of aging in the neat polymer, where pores with widths of <10 Å and 20-40 Å significantly diminished over time (FIG. 6c). In contrast to the neat polymer, the polymer with incorporated pNPs did not show alterations in the pore size distribution of the polymer matrix over time, indicating that the original porosity of the polymer matrix remains unchanged. This result together with those obtained in the sensor performance studies strongly support colloidal pNPs embedded in a polymer matrix as an attractive gas sensor system for physisorption-based sensing near ambient conditions.

This invention establishes a concept for a pNPs-polymer composites for sensor applications which is modular, and as such, contains several variables which can be adjusted and optimized for a particular application. A controllable interplay has been demonstrated wherein the operational wavelength of an FO RI-based gas sensor which functions through a gas ad(b)sorption mechanism can be tuned via the optimization of polymer refractive index, nanoparticle SPR absorption wavelength, and concentration of added SPR nanoparticles. The inclusion of pNPs into the polymer matrix have shown a unique ability to greatly reduce aging of the intrinsic pore structure of the polymer and thus preserve a high fraction of the surface area and free pore volume of the polymer. Stabilization of polymers of intrinsic porosity has direct application in not only the sensing application described herein, but also in gas separation processes involving solid sorbents and polymer membranes.

TABLE 1
Textural properties of fresh and aged
neat polymer and pNPs-polymer.

| | BET surface | Total pore |
|---|---|---|
| | area (m²/g) | volume (cm³/g) |
| Neat polymer (fresh) | 827.1 | 0.642 |
| Neat polymer (aged) | 69.5 | 0.098 |
| pNPs-polymer (fresh) | 485.7 | 0.365 |
| pNPs-polymer (aged) | 464.1 | 0.349 |

Note that the 40 wt % of nanoparticles in the polymer is very close to the value for the pure polymer (827.1 m²/g), indicating that inclusion of nanoparticles does not impact the intrinsic pore structure of the polymer. For example, if the pNPs-polymer had 40 wt % of nanoparticles, then the BET value would be normalized to the actual mass of polymer by dividing the value by 0.6. 485.7/0.6=809.5 m²/g.

1. An optical fiber comprising a layer of coating composition disposed on the exterior of a glass fiber; and wherein the layer of coating composition comprises:
plasmonic nanocrystals dispersed in a porous polymer; or
a composite comprising polymer and functionalized plasmonic nanocrystals.

2. The optical fiber of claim 1 wherein the plasmonic nanocrystals are functionalized with an amine or wherein the plasmonic nanocrystals are functionalized with (3-Aminopropyl)triethoxysilane, 1-Dodecanethiol, Trioctylphosphine, polyethylene glycol, ethylenediaminetetraacetic acid, polyvinyl pyrrolidone, polyvinyl alcohol.

3. The optical fiber of claim 1 wherein the plasmonic nanocrystals comprise indium-tin-oxide (ITO); or wherein the porous polymer has a volume average pore size in the range of 0.4 to 1.0 nm; or wherein the porous polymer has a pore volume is in the range of 0.1 to 1.0 cm³/g.

4. The optical fiber of claim 3 wherein the optical fiber has performance such that under a dry atmosphere containing one atm CO2 and 20 C there is a change of transmittance at near-infrared wavelengths of 20% or less over 300 days under the same conditions.

5. The optical fiber of claim 1 wherein the coating has a refractive index within 0.30 or within 0.10 or within 0.05 of the glass fiber.

6. (canceled)

7. The optical fiber of claim 1 further comprising an optical response enhancer in the coating that is a light absorbing material that, when present in the polymer matrix exhibits at least two times greater absorption, or at least 5 times, or in the range of 2 to ten times or five to ten times greater absorption of the light reflected from the sensor coating at the measurement wavelength as compared to the absorption from the coating without enhancer and as compared to the coating in the absence of CO₂ and CH₄.

8. The optical fiber of claim 1 wherein the plasmonic nanocrystals have at least one dimension in the mass average size range of 1 nm to 30 nm based on the smallest diameter of the particles.

9. The optical fiber of claim 8 wherein the plasmonic nanocrystals have spherical or rod-shaped particles.

10. The optical fiber of claim 1 wherein the length of the coating is 2 to 20 cm, more preferably 3 to 15 cm, more preferably 5 to 10 cm.

11. The optical fiber of claim 1 wherein the coating further comprises a zeolite or metal organic framework, or porous carbon.

12. The optical fiber of claim 1 wherein the polymer comprises PIM1 or PIM7 or PTMSP.

13. The optical fiber of claim 1 wherein the coating composition comprises 5-50 wt % plasmonic nanocrystals; and 60 to 95 wt % polymer.

14. (canceled)

15. The optical fiber of claim 1 wherein the thickness of the coating on the fiber is between 2 and 30 μm.

16. A sensor, comprising: a glass fiber coated with the coating composition of claim 1.

17. (canceled)

18. (canceled)

19. The sensor of claim 16 further comprising an impermeable protective tube comprising a fluid inlet and a fluid outlet and a fluid channel disposed between the fluid inlet and the outlet wherein the fluid channel contacts and is adjacent to the coated glass fiber, the sleeve, or the metal or plastic tube.

20. The sensor of claim 19 further comprising: a light source attached to one end of the glass fiber, a measurement device attached to the other end of the glass fiber; and a telemetry device.

21. A method of making a composite, comprising: functionalizing plasmonic nanocrystals with an amine; mixing the functionalized plasmonic nanocrystals with a PIM polymer to form a suspension; applying the suspension to a substrate, and curing or setting the polymer.

22. The method of claim 21 wherein the plasmonic nanocrystals comprise ITO or gold nanorods.

23. (canceled)

24. (canceled)

25. A method of measuring an amount of a molecule of interest, comprising:
exposing the sensor of claim 16 to the molecule of interest, and measuring light transmission through the fiber.

26. The method of claim 25, comprising: placing the sensor underground in an aqueous environment, exposing the sensor to the molecule of interest in the aqueous environment for at least eight continuous months and wherein the sensitivity of the sensor (signal intensity/analyte concentration) decreases by 20% or less.

27. (canceled)
